(19) United States
(12) Patent Application Publication
(10) Pub. No.: US 2008/0059290 A1
(43) Pub. Date: Mar. 6, 2008

(54) METHOD AND SYSTEM FOR SELECTING A CANDIDATE FOR A POSITION

(76) Inventor: William J. McFaul, Jackson, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/758,074

(22) Filed: Jun. 5, 2007

Related U.S. Application Data
(60) Provisional application No. 60/813,210, filed on Jun. 12, 2006.

(51) Int. Cl. G06Q 90/00

(52) U.S. Cl. 705/11

(57) ABSTRACT

A system and method to evaluate an individual's total qualifications so as to properly place an individual in position within an organization. The information gathered can then be used in the consideration, evaluation, and recruitment of employees. The method and system can also be used for employee placement, role assignment and/or team member selection in a workplace setting. The factors considered in determining a person's qualifications are their characteristics, skills and knowledge.

This application claims benefit of U.S. Provisional Application No. 60/813,210 filed on Jun. 12, 2006, the entirety of which is incorporated herein by reference.

### BACKGROUND OF THE INVENTION

1. Field of the Invention

The invention relates to the field of organizational management. In particular, the invention relates to a system and method for selecting and maintaining personnel for a business or organization.

2. Description of Related Technology

In the book, Good to Great, the need to focus on characteristics was addressed when it was written that “People can learn skills and acquire knowledge, but they cannot leant the essential character traits that make them right for your organization.” While this logic is critical in traditional businesses, the healthcare industry (e.g. healthcare provider organizations) and many technology based industries have historically focused on knowledge, such as specific clinical expertise, business acumen or highly specialized scientific experience as the primary factor for its hiring decisions and those related to the assignment of positions and roles.

An example of this can be found in the healthcare industry. Due to the nature of the healthcare industry, a major factor in finding qualified people has been centered on evaluating the knowledge required to provide quality outcomes for the treatment of sick patients. Such considerations have, over the decades, been embedded into the processes during recruitment and employee selection regardless of whether or not the positions are directly related to hands-on patient care. Only recently have some providers expanded their criteria to incorporate a wider view of all candidates by placing more weight on a person's characteristics.

U.S. Pat. No. 6,618,734 discloses a method for conducting an-employment screening and interview process. This method teaches the providing of behavioral tests as well as conducting interviews in order to fill a position.

Corporations are now placing a greater emphasis on having personnel with the “right” characteristics as an essential factor in creating a harmonious work environment as well as recognizing their importance as being critical to the formation of cohesion and collaboration two “missing links” in many work environments. While knowledge and skills are commonly learned in an educational environment or on the job, behavioral competencies are learned from life experiences and are the foundation upon which an individual can interrelate with others, stimulate their career and differentiate their persona in the workplace. Without the “right” characteristics, in a complex work environment like a HPO (Health Provider Organization), even the highest levels of skills and clinical/technical knowledge may not be enough to the deliver optimal results.

Therefore, there remains a need to provide an improved method and system for evaluating individuals for job positions.

### SUMMARY OF THE INVENTION

It is therefore an object of the invention to use characteristics, skills and knowledge of a candidate for evaluation for a position.

It is another object of the invention to evaluate mental functioning activity during the selection of the appropriate candidate.

It is a further object of the invention to provide a system for implementing the evaluation of a candidate's skills, knowledge and characteristics on a computer.

A first aspect of the invention can be A method for selecting a candidate for a position comprising: (a) creating a first test for evaluating knowledge of a candidate; (b) creating a second test for evaluating skills of a candidate; (c) creating a third test for evaluating the characteristics of a candidate (d) creating a fourth test for evaluating the mental functioning activity of a candidate; (e) administering the first test and the second test to the candidate; (f) evaluating the first test and the second test; (g) using the results of step (f) to determine if the third test is administered to the candidate; (h) administering the third test to the candidate; (i) evaluating the third test; (j) using the results of step (i) to determine if the fourth test is administered to the candidate; (k) administering the fourth test to the candidate; (l) evaluating the fourth test; and (m) using steps (a)-(l) in order to determine if the candidate is suitable for the position.

A second aspect of the invention can be a system for evaluating a candidate comprising: a computer programmed to administer a first test for evaluating knowledge of a candidate and a second test for evaluating skills of an individual; wherein said computer is further programmed to evaluate said first test and said second test in order to determine said skills and knowledge of said individual; said computer further programmed to determine from evaluating the first test and the second test whether to administer a third test for evaluating the characteristics of a candidate said computer further programmed to administer the third test to the candidate, wherein said computer is further programmed to evaluate said third test; and said computer further programmed to compare results of said first test, said second and said third test to a predetermined profile.

A third aspect of the invention can be A method for evaluating a candidate comprising: providing means for creating a first test for evaluating knowledge of a candidate, means for creating a second test for evaluating knowledge of a candidate and means for creating a third test for evaluating characteristics of a candidate; providing means for administering the first test, the second test and the third test to a candidate; administering the first test and the second; evaluating the first test and the second test to obtain a first set of results; comparing the first set of results to a first predetermined score; and administering the third test to the candidate if the first set of results is greater than the first predetermined score.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWING(S)

FIG. 1 illustrates the CSK set concept.

FIG. 2 is a chart illustrating the method.

FIG. 3 shows a sample skill assessment worksheet.

FIG. 4 shows a sample knowledge assessment worksheet.

FIG. 5 shows a sample characteristics assessment worksheet.

FIG. 6 shows a sample questionnaire for determining mental functioning activity.

FIG. 7 shows a sample clock.

FIG. 8 is a component diagram showing the elements of the system.

### DETAILED DESCRIPTION OF THE INVENTION

The present invention is a system and method which enables its user to evaluate an individual's total qualifications in order to gather a holistic evaluation of an individual so as to properly select the individual and/or place him or her in the proper position. The information gathered may also be used in the consideration, evaluation, and recruitment of employees. The method and system may also be used for employee placement, role assignment and/or team member selection in a workplace setting. The factors considered in determining a person's qualifications are their characteristics, skills and knowledge.

One of the factors used in this approach is the characteristics set (C Set) of an individual. The characteristics of an individual are those traits that govern how an individual will act in certain environments. One aspect of the C set may focus upon an individual's mental functioning activity (MFA), which is discussed in more detail below. Used herein the term “characteristics” generally refers to those character traits of an individual not encompassed by the term MFA. An individual's skills set (S Set) is an additional factor used in this method and system. An individual's skills are those traits that can be acquired through schooling or acquired through on the job training. An individual's knowledge is another factor used in this approach. An individual' knowledge set (K Set) is a factor verifiable through proven accomplishments.

Both skills and knowledge are essential considerations in evaluating a person's qualifications. However, since skills and knowledge can be developed (acquired or learned), they serve to compliment a person's characteristics as a major factor used to optimally “match” an individual to a desired position, function or role.

The applicability of this character, skill and knowledge (CSK) set evaluation process may be most apparent when considering the need to bring a group of individuals together to solve particular problems or to execute critical strategies. For example, in a highly complex work environment such as a health provider organization (HPO), the CEO may expect their Director of Supply Chain or their Director of Surgical Services to have all of the necessary interpersonal skills, appropriate technical knowledge and personal characteristics to single-handedly build a collaborative environment with the HPO staff. Such a task would be nearly impossible for a traditional cross-functional team. In today's challenging environment, a CSK set balanced, self-directed team may be the only way to effectively deal with such complex communication challenges. In industries, including healthcare, where the opportunity arises to hand pick individuals to execute critical tasks and to oversee the implementation of corporate strategies, a second and important level of the CSK set matching evaluation can be employed by determining the MFA of an individual. Usage of MFA testing can be performed in order to insure that the team is truly “balanced” with respect to each other.

As an example, in the in the healthcare industry, the focus on patient care has made the primary focus finding individuals with the clinical and technical K set to serve in management and leadership roles. While this factor is obviously important for the successful clinical outcomes of patients and to provide fellow employees with a safe environment, the selection of managers and leaders must also encompass an evaluation of their work related characteristics from their C set and interpersonal skills selected from their S set. Regardless of the industry, without using the appropriate C and S sets, managers as well as teams will perform at less than optimal levels regardless of the degree of knowledge they may possess.

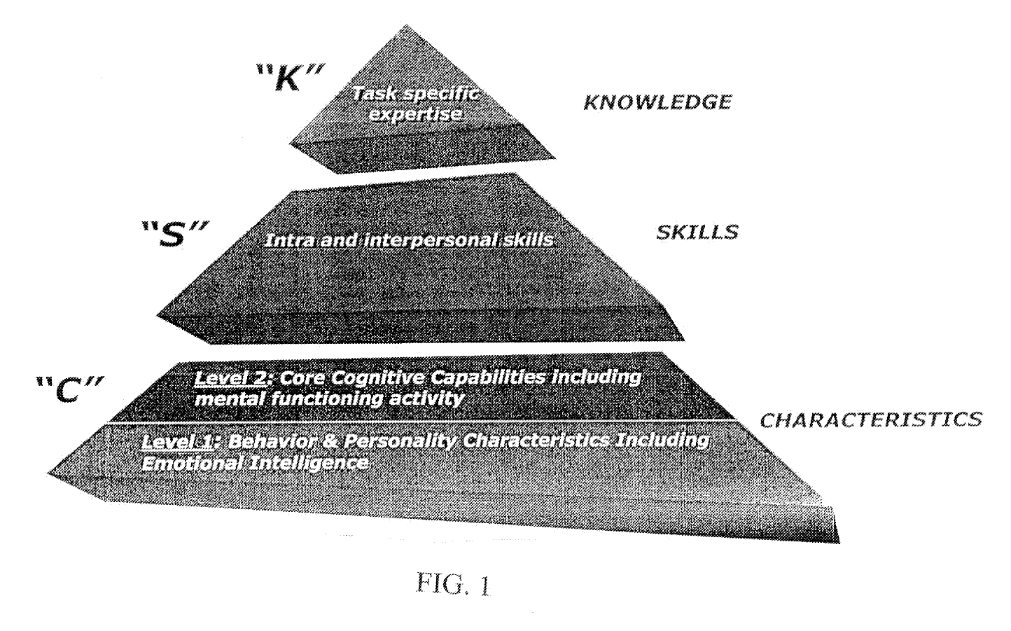

FIG. 1 graphically represents the present elements that are used in the practice of the present invention. The base is the core of the concept and it is represented and it is represented by the C set. Skills and knowledge is supported by the C set. Through the use of evaluation tools, the CSK set process determines the levels of all three factors.

A preliminary evaluation may be used to first determine whether a candidate possesses the minimum requirements for the desired S and K sets, such as the appropriate level and focus of education, a proven record of accomplishments in their field of expertise, computer skills, etc. After the preliminary evaluation the process also evaluates a candidate's characteristics. The analysis of the C set may be broken down into two levels. Level 1 of the character set analysis addresses “characteristics” which are personality and behavioral traits that a person exhibits. Level 1 of testing, or characteristic testing, is primarily intended to be used as a screening mechanism. Due to the nature of some middle management and executive positions in leadership, candidates may also be subjected to additional testing. Level 2 testing is based on MFA. This pan of the process consists of evaluating the MFA of the candidates. While level 1 of the character set analysis may be a useful tool for screening team members, it does not provide the information that MFA testing provides in determining the critical aspects associated with team balancing.

Once it is determined that an acceptable mix of characteristics, skills and knowledge exists, the individuals can be then further evaluated in depth. Related training and development may also be provided to select individuals in order to match an organization's specific culture and needs. This is offered in order to enhance the capabilities of accepted individuals. This training and development stage may also include areas that are role specific based on the responsibilities that a position may require.

The CSK set for evaluating individuals can be modified to be used for a variety of applications related to successfully filling a position and other human resource tasks. One such application is employee selection and hiring for all types of positions; including supervisory, management and can be executive positions. Another application can be employee role assignment, such as promotions, transfers, and restructuring. The method and system may also be used in screening for the first level of dynamic team creation in order to determine both roles and criteria for teams and candidates within operating teams or the organization as a whole when viewed from the perspective of being a team. The process may also be used to develop statistical standards for creating employment profiles and notices for job postings and solicitations to fill vacancies. Another application is as an organizational development tool and process to create a common language throughout an organization. The process may also be for maintaining appropriate levels of homogeneity of employees in order to match predetermined criteria for the organization's desired culture. The CSK set may also be used to identify, educate, train and cultivate leaders and members of teams which are structured in order to balance the membership based on MFA. Yet further applications of the CSK set may be as an evaluation tool for existing employees, teams and departments to optimally match organizational resources. This can be accomplished by measuring the current level of knowledge and skills in order to determine what levels of additional education, training and coaching may be needed. The method may also be used by individuals themselves in order to find a position suitable for them.

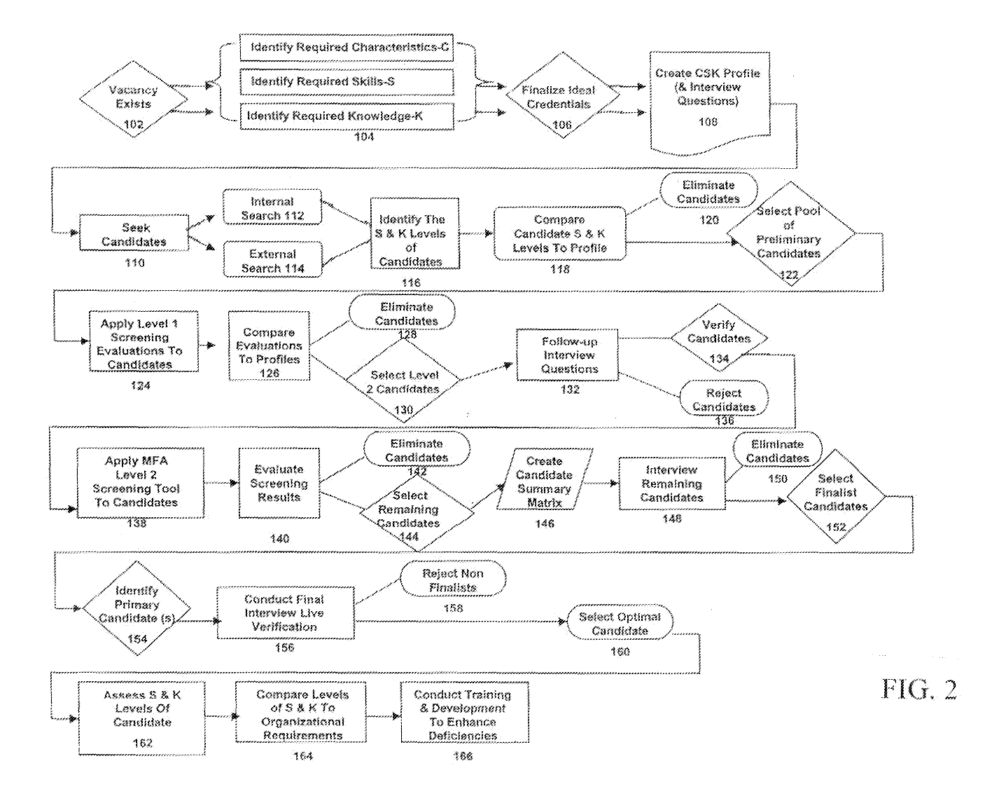

Now turning to FIG. 2, which diagrammatically represents the steps used in a preferred embodiment of the method and system for selecting an individual for a position.

The evaluation process begins at step 102 after an open position has been identified within an organization. This “position” is defined as an organizational “need” manifested in the form of an employee, or staff requirement. It may be a newly created position, a replacement position, a team member opening or need, an employee promotion, or transfer. It should be understood that the term “position” is not limited to jobs paid with money but also incorporates volunteer and other non-paid or compensated roles.

Before any steps to fill the position are taken, criteria and parameters must be created in which to evaluate individuals. In step 104 the identification of the required parameters of the evaluation process occurs. This involves identifying the characteristic, skills and knowledge sets that are desired for the position. This step of the holistic process examines and evaluates the knowledge, skills and characteristics of individuals who previously occupied this position. Also taken into consideration are the conditions and requirements specific to the department or direct area of influence that the position handles. This information is used to develop a profile for each of the categories.

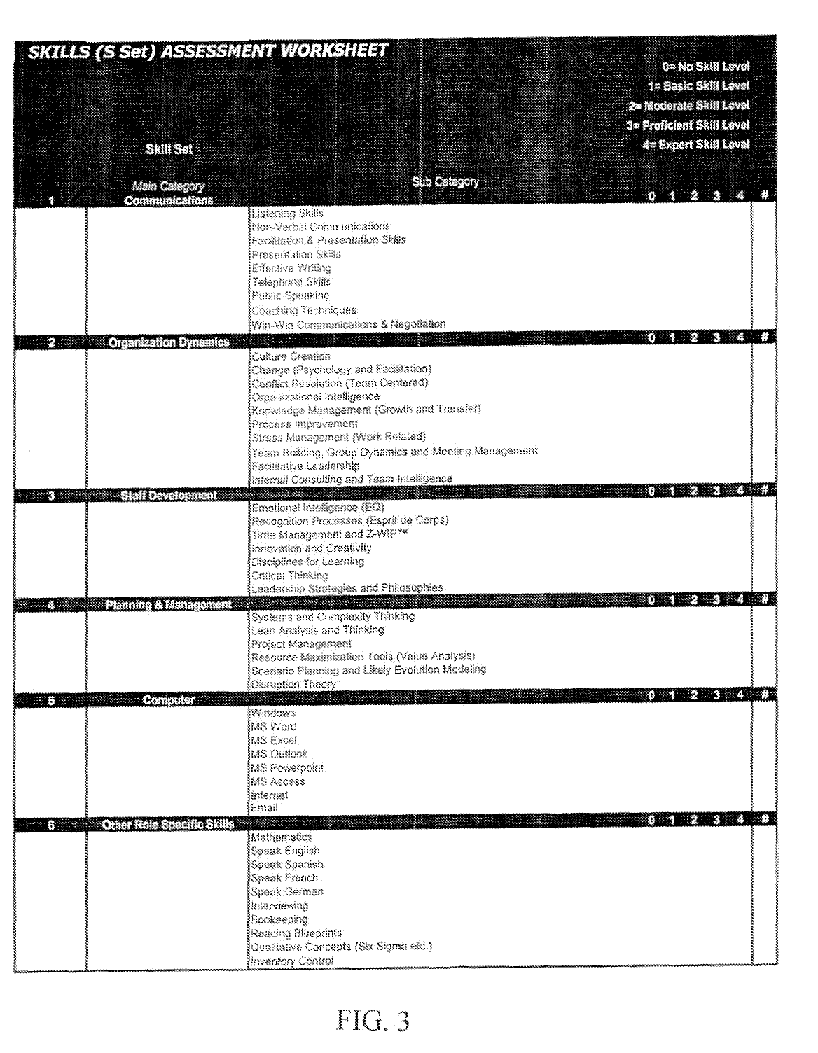

This evaluation may be performed via interviews with related organizational personnel consisting of the tools shown in FIGS. 3, 4 and 5. These tools can be used to identify skills, characteristics and knowledge sets. FIG. 3 shows a sample skill assessment worksheet. In the example shown some the skills explored are communications, organization dynamics, staff development, planning and management and computer. Other skill specific skills may be chosen for the purposes of the evaluation depending upon the nature of the job.

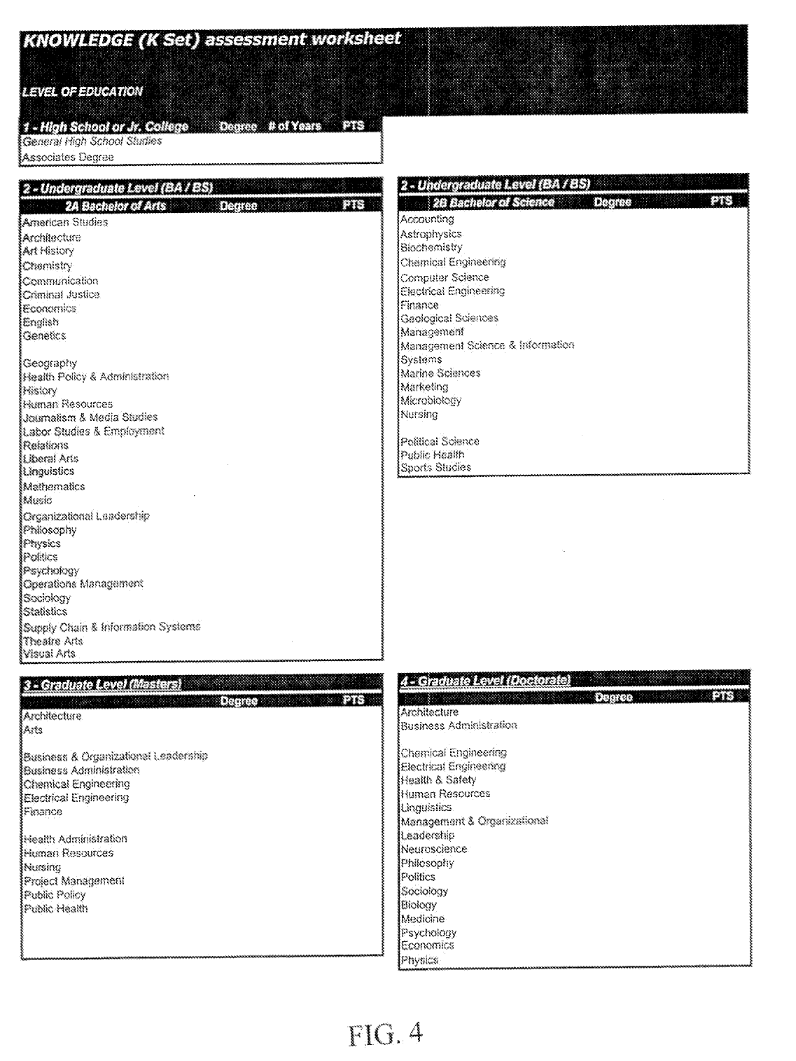

FIG. 4 shows a sample knowledge assessment worksheet. The sample shown explores the educational levels that a person has achieved.

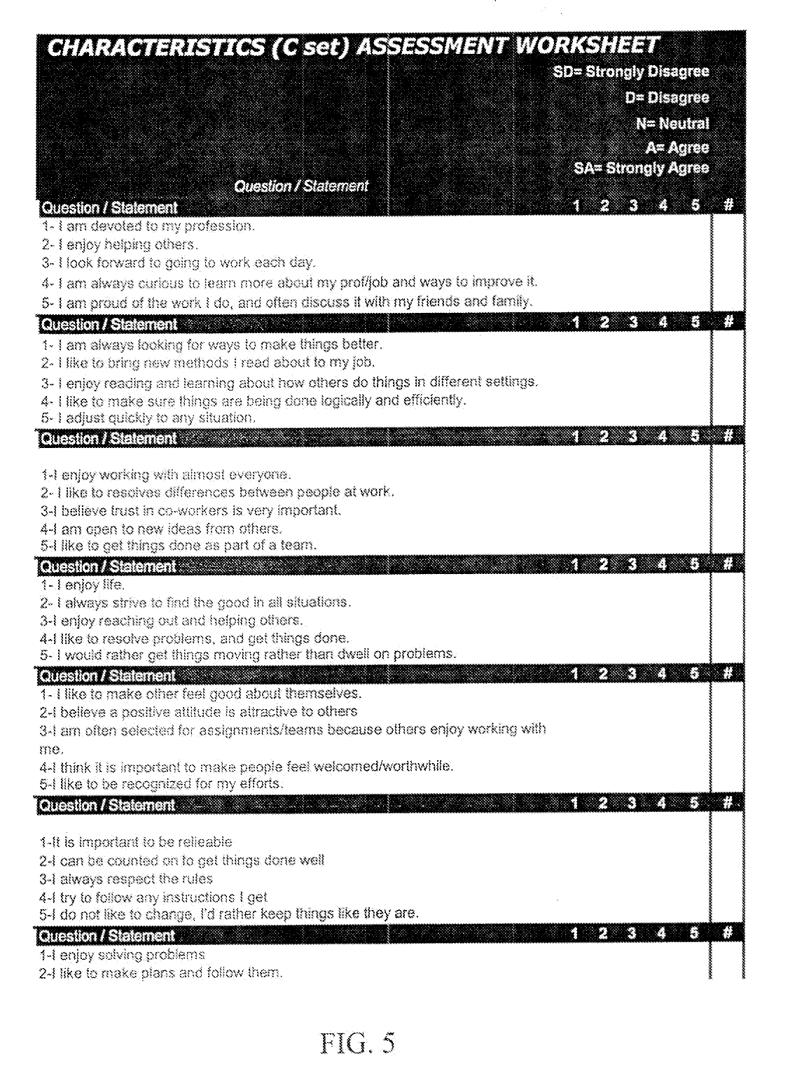

FIG. 5 shows a sample characteristics assessment worksheet. The questions found in this sample sheet explores various aspects of the individual's character traits. These are explored through the asking of questions such as “I enjoy life.”

The above described worksheets serve as examples of assessment tools that can be used to assist in ascertaining the individual's CSK sets. The contents of the worksheets can be customized based on the position available. Once the ideal profile is developed. Each category used in the worksheet and corresponding sub category may contain an optimal score, developed from the profile that should be met in an effort to optimally match an individual to the requirements of the position.

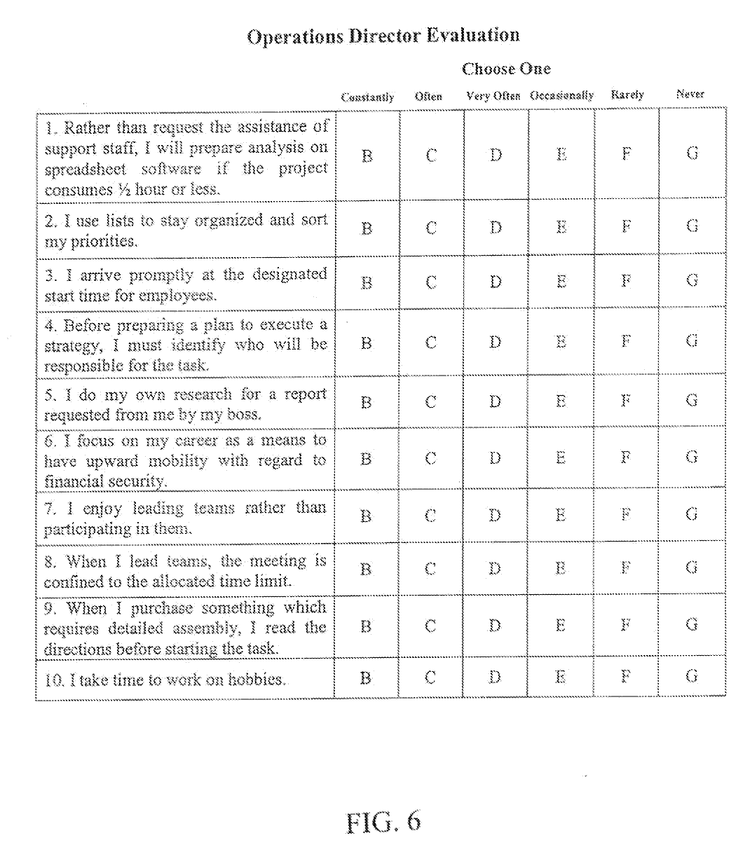

An example of such customization is illustrated in section 6 of FIG. 3, entitled “Other Role Specific Skills.” While the previous sections, 1-5, list non-specific skills that may or may not apply to the need the position presents, section 6 lists some skills may best meet the need of a specific position. It should be noted that each section and subsection of the examples in Exhibits 3, 4 and 5 are flexible and customizable in such ways as illustrated in FIG. 6.

In step 106, once the optimal “levels” or “scores” are determined for each of the sections in the assessment sheet, the data is gathered and manipulated to create the standard by which all candidates for the position will be compared. The ideal credentials are finalized throughout the process, this will form the CSK set profile. The CSK set profile may be score or series of scores that are used to establish the target value for a potential candidate to meet during the testing.

In step 108, the CSK set profile will consist of the optimal and/or minimal “scores” needed in each category and corresponding subcategory. The “scoring” can follow a customizable mathematical system of weighting each of the subcategories contained within the assessment worksheets.

For example, a minimum score or level of 30 points may be needed to qualify for a position. Depending on the needs of the position, scoring can be weighted in such a way that would reward education that is concentrated in an area that has direct relation to the position. This example proposes that the vacancy is for a Chief Financial Officer. The weighting of the scoring might give 10 pts for a high school degree, 1.5 points for a BA in mathematics, but 20 pts for a BA in Economics. The high school degree and BA in economies would give a potential candidate the minimum point level to satisfy the profile. Certain categories may be weighted in order to provide extra emphasis, such as graduate level education.

In the example, in developing the CSK set profile, in addition to the knowledge profile worksheet, the skill and characteristic profile worksheets are also used. Each profile worksheet may be a customized, mathematically calculated and weighted variation of those shown in FIGS. 3, 4 and 5. In establishing the profiles minimum levels of “scoring” as well as parameters for acceptable ranges of scoring should be used that will satisfy the criteria set within the C, S and K set levels.

Also part of step 108 may be the development of a customized list of interview questions that will be asked at a later stage in the process. These questions should be tailored to the specific requirements of the position and will be customized in order to further develop the profile. Provided below are some sample interview questions that might be used in process:
1. What qualities do you feel a successful manager should have?
2. Do you have any location preferences?
3. How familiar are you with the community that we're located in?
4. Are yon willing to relocate?
5. Are you willing to travel? How much?
6. Is money important to you?
7. How much money do you need to make to be happy?
8. What are year salary requirements?
9. Tell us what you know about our organization?
10. How would you describe your work ethic?
11. What kind of preparation did you do for this interview?
12. Do you handle conflict well!
13. Do you think that you are a leader? If yes, give us an example.
14. How you ever spoken to a large group of people? How large? Tell us about it.
15. What do you offer that your competition for this position cannot?
16. Everyone has certain likes and dislikes. What kind of people do you like? Dislike?
17. How are you in dealing with stressful situations? Give an example.
18. What would you mast like to accomplish if you had this job?
19. Give us three examples of what would make you leave this job?
20. What was your most difficult decision in the last six months? What made it difficult?
21. Describe the best supervisor you've ever had.?
22. What approach do you take in getting your people to accept your ideas or department goals?
23. Do you feel you work more effectively on a one to one basis or in a group situation?
24. What two projects come to mind on which you failed? Why? What would you do to prevent the same thing from happening again?
25. What kind of environment would you like to work in?
26. Tell me about the work situation that irritated you the most in your career.
27. What factors motivate you the most?
28. What are some of your hobbies?
29. Do you belong to any organizations? If so, which ones?
30. Have you ever been fired or asked to resign from a job? Why?
31. Do you foresee any obstacles to having a long-term relationship here?
32. Are you capable and willing to endure frequent and sometimes lengthy travel assignments?
33. If hired right now, what goal would you have with the company in the first 90 days? In one year?
34. Give me an example of an important goal which had been set for you and about your success in reaching.
35. How do you feel when you fail to meet a goal?
36. When taking on a new task, do you like to have a great deal of feedback and responsibility at the outset, or do you like to try your own approach?
37. What experience have you had with miscommunication with a customer or fellow employee, and how did you solve the problem?
38. What experience do you have in coaching and mentoring employees?

A portion of the questionnaire used may contain a traditional job description that includes the job title, areas of responsibility, industry specific information, etc. This portion may be used to inform potential applicants as to the basics of the position. This description can be provided by or created by the Human Resources Department of the organization who has the actual position.

At step 110, once the assessment sheets, questionnaires and/or diagnostic tools have been created, a search for an appropriate candidate for the position can commence. The search may begin as a basic recruitment initiative conducted through traditional means, such as job postings, internet job sites, advertising, etc. these can be used to invite candidates to apply for the position.

At step 112 and step 114, the search for candidates may be performed externally (i.e. outside the organization) and/or internally (i.e. inside the organization). The requirements of the position may be used in order to determine where the search should be conducted. An example of when an exclusive internal search could be conducted is a situation where an organization would be looking to create a team tasked with certain role specific responsibilities with the organization. In such an instance an internal search may make more sense, and the candidate pool would already have many of the necessary requirements to meet the needs based upon a working knowledge of the organization.

A candidate may be defined as anyone who can potentially fill the position. At this point of the process, a pool of potential candidates may be created. The pool encompasses all candidates identified in the search process. At this step in the process candidates may begin to be evaluated.

At step 116, the identification of the S and K set “levels” of the candidates occurs using the assessment sheets. The sheets used in determining these levels are variations of the previously created profile worksheets that are used to establish those qualities that are important for the position. The variations include applications of mathematically balanced and weighted scoring systems that are based on the original profile. These worksheets are completed either by the candidates as part of this step in the application process or by the administrators of the process who administer the tests. The worksheets may be provided via a computer system or via a manual system.

At step 118, alter the candidate's S and K levels are identified via use of the candidate evaluations, a comparison is made between the results and the overall candidate profile levels that were established in step 108. As established in step 108 individual scores or levels for each S and K category have been established in order to form the ideal customized candidate profile. The candidate's evaluation scores are compared to the ideal profile that was initially created in order to determine if they meet the “minimum” requirement so as to continue as viable candidates.

At steps 120 and 122, based on the comparison that occurred at step 118, preferred candidates are selected. The preferred candidates are those that rise to an acceptable level in terms of appropriate skills and knowledge. A preliminary candidate pool is created using the preferred candidates. Those included in the pool continue on in the process. Those candidates who do not meet the minimum requirements based on the comparison are eliminated as candidates.

At step 124, level 1 character screening evaluations are provided to the candidates. The level 1 character screening evaluates the candidate's characteristics. As noted above testing of a candidate's characteristics is separate from testing of a candidate's MFA. An example of a variation of the tool used for determining a candidate's characteristics can be found in FIG. 5. Similar to the skill and knowledge evaluation tests performed in step 116, this evaluation can use the previously created and calculated candidate assessment worksheet that had been developed for defining the position. The customized character assessment sheet contains the inclusion of a mathematically balanced and weighted scoring system. These evaluations are completed either by the candidates or by an administrator of the process and can be administered in electronic form, via the internet or software, in written format, and/or in interview format. It should be understood that although reference is made to FIG. 5, other diagnostic tools, maybe used in place of the shown tool.

At step 126, the results of the characteristic evaluations are compared to the established ideal profiles in order to determine the viability of the candidates. As with the S and K evaluations, a level or score for each of the candidates is determined and compared against that of the preferred score that an ideal candidate would have for the given position.

At steps 128 and 130, based upon step 126 the candidates are again placed into smaller groups. Those who fail to have acceptable characteristics, or whose scores fall below a certain level are eliminated and the level two candidates are selected. Those level two candidates selected will continue on in the selection process.

At step 132, follow-up interview questions may be provided to those candidates that have been selected in order to further reduce the number of potential candidates. This step can be optionally performed in order to verify that the candidates selected at step 134 are good candidates. Candidates who perform poorly at step 136 are subsequently dismissed.

At step 138, level 2 screening of the candidates may take place. At step 138 tests for determining mental function activity are used to evaluate the candidates. Traditional methods of personality profiling alone, such as those used in the level 1 evaluations, fall short of providing an adequate assessment of how employees or team members are likely to perform in their position. It should be understood that the term “mental function activity” refers to a specific subset a persons characteristics.

Personality traits, such as those determined in the level 1 screening, are the actions or behavioral characteristics of individuals which are frequently compared by various testing methodologies with the norms of others. Since these actions are the images or impressions others use to assess our anticipated mannerisms, people attempt to portray the most desirable traits to match and/or be compliant with various circumstances and environments.

MFA is a terra used to illustrate a spectrum of possible mental and behavioral characteristics correlated with their actual or categorized brain activity. For example some characteristics that make up MFA are focus, such as obsession, over-focus, awareness and disinterest; temperament such as rage, anger, aversion, and disenfranchisement; concern, such as fright, tear, sadness and despair; happiness, such as resentment, bitterness, joy, envy and avoidance; and physical behavior, such as overly-active, active, lethargic and sedentary. MFA provides a gauge that helps ascertain a person's ability to dedicate greater or lesser focus on tasks and their ability to handle tasks. MFA can also be used as a gauge to determine potential physical health effects that have been shown to correspond to various levels of MFA. MFA can be used to help establish people's mental health for the purpose of diagnosis and/or treatment by mental health professionals. MFA can also be used as a gauge for determining a rate of activity of the body's immune system and other physiological activities. Furthermore, the various bands of thought process discussed above may have specific MFA levels attributed to them, and the MFA of the different bands of thought assessed individually.

In general, the mental functioning activity is more intimately related to the physical functioning of the brain and may be further visualized using magnetic resonance imaging or other physical diagnostic tools. However, in the event that the usage of physical imaging cannot be used, it is possible to use specially formatted questionnaires in order to gauge the level of MFA.

An example questionnaire, that may be used to determine MFA, is found in FIG. 6, which illustrates a test for an operations director. This test is a customized example of a sample test that is used for an available position of an “Operations Director” in a generic business setting. The questions may be selected from a “master” worksheet, or a database of acceptable questions that illicit appropriate gauging of mental functioning activity. Alternatively, the questions may be developed specifically for the sought after position.

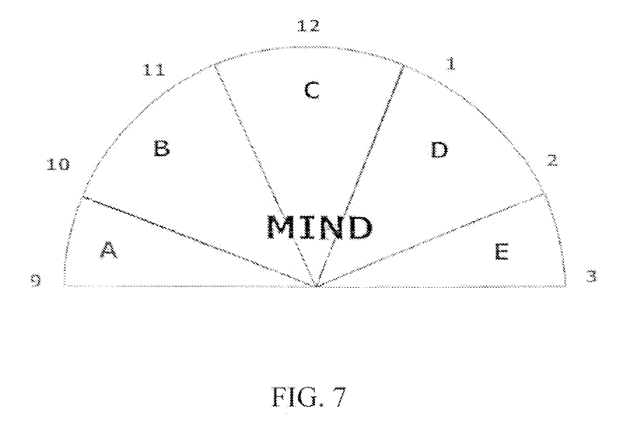

As a method for easily referencing the MFA of an individual a person may be given a categorization number such as 9-10-11-12-1-2-3, as a result of completing the test. These numbers are based upon positions of a clock, such as that shown in FIG. 7. For example, under the topic of “leadership,” an individual selecting “collaboration” as their most likely assumed “role” as it relates to that topic would fell into the “12” category. The sample “test” questions of which FIG. 6 is comprised have a customized sampling of topics chosen for relatedness to the requirements of the position. The positions of the clock move from 9 being over focused and larges amounts of MFA to 3, which is a low amount of the MFA. Too much MFA is just as ineffective as too little. At position 12 the MFA level may be considered balanced.

In step 138, the level 2 evaluation of the MFA is performed and diagnosed based on the requirements of the position. The criteria established during the initial assessment phase may be used and/or incorporated into the level 2 evaluation. The level 2 mental functioning evaluation may be completed either by the candidates as part of this step in the process or by an administrator of the process and can be administered in electronic form, via the internet or software, in written format, and/or in an interview format.

At step 140, the results of a completed level 2 MFA evaluation are used to score the candidates. The candidates may be placed into a category that represents their respective mental functioning activity, such as 9-10-11-12-1-2-3, with each of categories defining a different level of thinking. All definitions of the positions on the clock categories are customizable. The candidates score on the clock is then compared to that of the ideal MFA that is desired for the position. A detailed explanation of MFA may be found in U.S. application Ser. No. 11/677,306, the contents of which are hereby incorporated by reference. It should be understood that the process of testing the MFA may be implemented by a computer system that provides questionnaires and automatically scores them. It is also possible to take a physical measurement of the MFA of an individual and apply it to the classification system discussed above.

An example of the usage of the process would be the classifying of people for an analytical position. In this example, MFAs that are categorized around the 10 or 11 position would be desired since this would indicate that the person is more focused than those who are at the 2 or 3 position, which would indicate that the candidate is more creative than focused and analytical.

At steps 142 and 144, based on the evaluation of the level 2 candidates, qualifying candidates are selected. Those candidates that fail to have the proper mental functioning activity are eliminated at step 142. The viable candidates will continue on in the process

At step 146 a summary matrix may be created of the remaining candidates. A matrix may be selected due to ease of use when viewing the contents. The summary should include at a minimum all of the evaluation results for each candidate. This summary may assist the administrator of the process and or others involved in the process in subdividing the remaining candidates info small, specialized groups. These remaining candidates have already demonstrated that they have an appropriate knowledge level, skill level, level 1 characteristic level, and level 2 characteristic level. These scores can be analyzed and weighted based upon those tests that demonstrate the most desired characteristics.

At step 148 the remaining candidates may be interviewed. These interviews may be conducted by the administrator of the process and or members of the organization that has the position. The questions asked in the interview may include those compiled as part of the initial identification of the ideal CSK set created at the beginning of the process. The questions may also be formulated based upon the information gathered up to this point. This information can include, but is not limited to all of the previous evaluations and screening results: there could also be an additional, customized group of questions that could be used to validate the results of the previously completed evaluations.

At step 150, based upon the interviews performed in step 148, candidates are rejected. At step 152 the final candidates are selected and remain in the group of continuing viable candidates and will continue on in the process. The remaining candidates in the process may now be considered finalists.

After the finalist candidates are identified in step 154, at step 156 the final interviews are conducted. The final interview(s) will go in depth with the remaining candidates, concentrating on areas that may remain a concern to the organization filling the position. The final interviewer(s) can include key members of the organization and possibly the CSK set administrator.

At step 158, based upon these final interviews those who are deemed not to qualify are rejected. At step 160 the optimal candidate(s) are selected. If multiple candidates remain, the organization (the decision making members) along with the possible input of the CSK Set administrator will select the best candidate.

Once the best candidate is selected to fill the position, the CSK set process does not need to end. In an effort to enhance the “performance” of the candidate as it relates to his or her activities and responsibilities within the organization, a skills and knowledge development process may be also administered. This process can be used in order to further enhance the quality of the candidate. Those areas that had been proven to be deficient during the process can now be specifically targeted and addressed.

The CSK set process should have already identified the candidate's levels of skills and knowledge based on the evaluations performed in step 116, and further examination(s) conducted during the interviews. At step 162 the skills and knowledge of the candidates is revisited and a possible re-evaluation of the needed criteria is made by the process administrator and/or a member of the organization.

The information gathered in step 162 is compared to the organizational requirements at step 164. This is used to further determine areas of deficiency in the skill and knowledge levels that may exist in the newly hired candidate. These areas maybe noted and documented.

At step 166, the candidate (or group of candidates) within the organization that have been identified to have a “need” for skills and knowledge enhancement are further trained and educated in order to correct the deficiency. The training and development is a customized application dependent upon the situation, subject matter and personnel involved. This step may be conducted by a member of the organization, such as a trainer, a HR member, organizational development personnel, and/or the CSK set administrator. This step is administered in order to enhance the performance of a newly hired employee selected through the CSK set process although it may also be applied to existing members of an organization or a team.

The CSK set process including all of its ideal profile establishment, evaluation process and screening steps has many applications within an organization. The process has many uses other than to fill a position as discussed above. The CSK set process can be applied to a variety of organization settings including but not limited to: new hire selection, recruiting, team member selection, team creation, organization development, human resources, employee evaluations, promotions, and profiles.

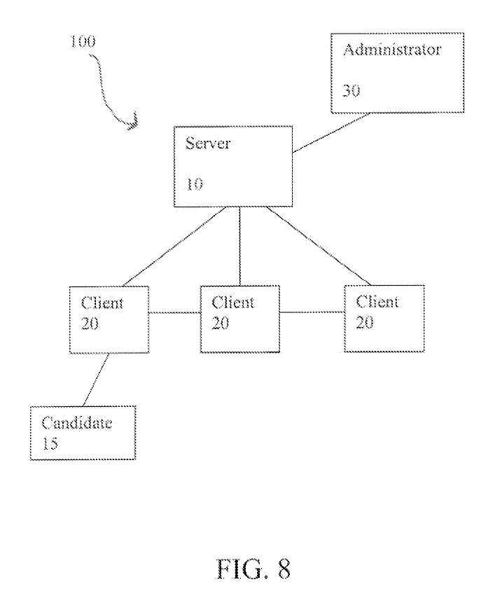

Now referring to FIG. 8, which shows a diagram of a CSK set system 100 in which the automated process maybe implemented. The entire automated process may use the system 100 of computers and networks. The CSK set process can be implemented as software installed on computers. The system 100 shown in FIG. 8, uses a server 10, the clients 20, a candidate 15, and an administrator 30. The server 10, may be a computer, a series of computers and other data storage facilities. The client 20 may be a terminal, computer, or other electronic device that is capable of receiving data from the server 20. In the embodiment shown foe server 10 has the program installed on it. The program stored at the server 10 is streamed to the various clients 20 that are located within the network. The server 10 and the clients 20 can be part of an intranet and/or an internet. Each of foe clients 20 may be networked with each other as well as the server 10. Alternatively, it is possible to have the clients 20 be each programmed with the process.

Still referring to FIG. 8, the various tests and questions are answered at the client 20 by the candidate 15. It is possible to integrate personal interviews into the automated process by stopping the automated process and conducting the interviews. Alternatively, the interviews may not be implemented or the client 20 may be adapted to conduct the interview by conducting it via the internet and/or intranet by using chat programs, or video conferencing, which may be conducted by the administrator 30. The administrator's questions may be pre-recorded and responses may be recorded and analyzed based upon detection of certain words, etc. Facial analysts software could also be used in order to analyze the expressions of the candidate 15 being interviewed.

Results can be automatically calculated and used to move the candidate 15 onto the next level. The automated process may be stopped when the candidate 15 fails to successfully pass the evaluation of and earlier stage. The automated system 100 may also use the results in order to provide the successful candidate with the necessary job information and if necessary to further instruct him or her to attend additional training or education.

It is to be understood, however, that even though numerous characteristics and advantages of the present invention have been set forth in the foregoing description, together with details of the structure and function of the invention, the disclosure is illustrative only, and changes may be made in detail, to the full extent indicated by the broad general meaning of the terms in which the appended claims are expressed.

What is claimed is:

1. A method for selecting a candidate for a position comprising the steps of:
(a) creating a first test for evaluating knowledge of a candidate;
(b) creating a second test for evaluating skills of a candidate;
(c) creating a third test for evaluating the characteristics of a candidate
(d) creating a fourth test for evaluating the mental function activity of a candidate;
(e) administering the first test and the second test to the candidate;
(f) evaluating the first test and the second test
(g) using the results of step (f) to determine if the third test is administered to the candidate;
(h) administering the third test to the candidate;
(i) evaluating the third test;
(j) using the results of step (i) to determine if the fourth test is administered to the candidate;
(k) administering the fourth test to the candidate;
(l) evaluating the fourth test; and
(m) using steps (a)-(l) in order to determine if the candidate is suitable for the position.

2. The method of claim 1, further comprising conducting an interview with the candidate.

3. The method of claim 1, further comprising conducting an interview with the candidate after steps (i) and (l).

4. The method of claim 1, wherein the step of evaluating the fourth test places the candidate into a category selected from the group consisting of 9, 10, 11, 12, 1, 2, and 3.

5. The method of claim 1, wherein said first, second and third tests are weighted.

6. The method of claim 1, wherein steps (a)-(d) are used to create a profile score.

7. The method of claim 1, wherein steps (e)-(l) are performed using a computer.

8. The method of claim 1, further comprising using steps (f), (i) and (l) to provide additional training to the candidate.

9. A system for evaluating a candidate comprising:
a computer programmed to administer a first test for evaluating knowledge of a candidate and a second test for evaluating skills of an individual; wherein said computer is further programmed to evaluate said first test and said second test in order to determine said skills and knowledge of said individual;
said computer further programmed to determine from evaluating the first test and the second test whether to administer a third test for evaluating the characteristics of a candidate;
said computer further programmed to administer the third test to the candidate, wherein said computer is further programmed to evaluate said third test; and
said computer further programmed to compare results of said first test, said second and said third test to a predetermined profile.

10. The system of claim 9, wherein said computer is further programmed to administer a fourth test for evaluating the mental function activity of said candidate.

11. The system of claim 10, wherein said computer is further programmed to evaluate said fourth test.

12. The system of claim 11, wherein evaluation of said fourth, test places the candidate into category selected from the group consisting of 9, 10, 11, 12, 1, 2, and 3.

13. The system of claim 12, wherein said computer is further programmed to compare the results of said first test, said second test, said third test and said fourth test to a predetermined profile.

14. The system of claim 9, wherein said computer is a server programmed to provide said first, second and third test to a client.

15. The system of claim 14, wherein said first, second and third tests are weighted.

16. The system of claim 14, wherein said computer is adapted to conduct an interview with said candidate.

17. The system of claim 9, wherein said computer is further programmed to schedule training for the candidate based upon results of said first, second and third tests.

18. A method for evaluating a candidate comprising;
providing means for creating a first test for evaluating knowledge of a candidate, means for creating a second test for evaluating knowledge of a candidate and means for creating a third test for evaluating characteristics of a candidate;
providing means for administering the first test, the second test and the third test to a candidate;
administering the first test and the second;
evaluating the first test and the second test to obtain a first set of results;
comparing the first set of results to a first predetermined score; and
administering the third test to the candidate if the first set of results is greater than the first predetermined score.

19. The method of claim 18, evaluating the third test to obtain a second set of results and comparing the second set of results to a second predetermined score.

20. The method of claim 19, further comprising providing means for creating a fourth test for evaluating mental function activity, administering the fourth test to the candidate and evaluating the fourth test.
